(19) United States
(12) Patent Application Publication
(10) Pub. No.: US 2026/0109507 A1
(43) Pub. Date: Apr. 23, 2026

(54) BATTERY CELL TRAY FOR TRANSPORTING BATTERY CELL

(71) Applicants: DONG YANG PHYSICS & CHEMICAL CO., LTD., Anseong-si (KR); SK On Co., Ltd., Seoul (KR)

(72) Inventors: Seung Hyun LEE, Seoul (KR); Yongjae JEON, Daejeon (KR); Dayoung LEE, Daejeon (KR); Junwoo RYU, Daejeon (KR); Sanghyun KIM, Daejeon (KR)

(21) Appl. No.: 18/918,538

(22) Filed: Oct. 17, 2024

(51) Int. Cl. B65D 1/36; B65D 1/46; H01M 50/256

(52) U.S. Cl. CPC B65D 1/36; B65D 1/46; H01M 50/256

(57) ABSTRACT

Provided is a battery cell tray for transporting a battery cell. The battery cell tray features a double-walled structure to minimize lateral movement by vertically coupling upper and lower-stage battery cells when stacking the battery cell trays in multiple stages. It also includes a rib to prevent foreign substances, generated during the vertical coupling of the battery cell trays, from being introduced into the cell seating part. This prevents foreign substance introduction and battery cell damage during secondary battery transport, thereby improving safety and reliability during transportation.

### BACKGROUND

The present disclosure relates to a battery cell tray for transporting a battery cell, and more particularly, to a battery cell tray that may improve transportation safety and reliability by preventing foreign substances from being introduced and preventing the battery cells from being damaged during the transport of a secondary battery.

Secondary batteries are widely used not only in small mobile devices but also in medium and large devices such as electric vehicles, hybrid electric vehicles, and power storage systems. To increase capacity and output, battery cells like pouch-type secondary batteries, which are easy to stack and lightweight, are used by connecting a plurality of them together. When transporting secondary batteries in large quantities, a battery cell tray for transporting battery cells, which has spaces to accommodate a plurality of secondary batteries, may be used These battery cells are accommodated in the tray, and the trays in which the battery cells are accommodated are stacked in multiple stages inside a transportation box and transported.

In the existing battery cell trays for transporting the battery cells, when stacking battery cells in multiple stages, a plurality of cylindrical protrusions are provided in a row at a predetermined interval along an edge or central portion of the battery cell tray, and recesses corresponding to the shape of the protrusions are defined in a bottom surface of the battery cell tray to accommodate the protrusions. That is, a method in which the protrusions couple to the recesses has been used.

However, in the battery cell tray for transporting the battery cell, which has such a structure, the protrusions may be broken due to friction when the battery cells are accommodated, resulting in the detached foreign substances may either be introduced into a battery cell seating part, or foreign substances introduced from outside may be introduced into the battery cell seating part. This may result in dents, scratches, or cracks on the battery cells. Such damage to the battery cells may lead to deterioration in battery quality and may cause equipment malfunction.

### SUMMARY

The present disclosure provides a battery cell tray for transporting a battery cell, which may securely couple the battery cell thereto by preventing lateral shaking even when stacking battery cells in multiple stages.

The present disclosure also provides a battery cell tray for transporting a battery cell, which may prevent foreign substances generated by friction when vertically coupling the battery cell trays to each other, from being introduced into the battery cell seating part, thereby preventing surface damage such as scratches, creases, dents, or scrapes on the battery cell. Ultimately, the battery cell tray for transporting the battery cell may ensure excellent transport safety.

The present disclosure also provides a battery cell tray for transporting a battery cell, which may minimize contact and friction between upper-stage battery cell tray and lower-stage battery cell tray, which are stacked in multiple stages, thereby preventing product damage and ensuring the maintenance of battery performance and reliability.

In accordance with an exemplary embodiment of the present invention, a battery cell tray for transporting a battery cell includes: a main body; and an edge part defining an outer portion of the main body; wherein the main body includes: one or more cell seating part having a groove shape, to which battery cells are accommodated; and a lead accommodation part in which a lead of the battery cell is accommodated, the lead accommodation part extending from both side portions of the cell seating part in a long-side direction, wherein the edge part has a double-walled structure constituted by a top surface, inner and outer walls extending downward from the top surface to face each other, and a pair of bending corner parts provided between the top surface and the inner and outer walls, an inner wall of an upper-stage battery cell tray is seated in a recess part in which the inner wall is accommodated, and a rib is defined at a predetermined height on an inner end of the recess part to prevent foreign substances from being introduced to the cell seating part.

The battery cell tray may further include a plurality of cylindrical support parts disposed between the cell seating parts in the center of the main body to prevent the battery cell tray from drooping when stacking the battery cell tray in multiple stages, wherein each of the cylindrical support part may include: an edge protrusion protruding at a predetermined height upward from a surface of the battery cell tray, and a leg part disposed on a bottom surface of the battery cell tray, wherein the leg part of the upper-stage battery cell tray is seated inside an edge protrusion of a lower-stage battery cell tray.

The battery cell tray may further include a drooping prevention structure in which a cross-shaped linear rib is provided around the leg part.

Surfaces of the upper-stage battery cell and the lower-stage battery cell tray may not be in contact with each other except for the edge part and the cylindrical support part.

The battery cell tray may further include a through-hole for detecting the battery cell, which is defined in a central portion of the cell seating part to visually confirm whether the battery cell is accommodated in the lower-stage battery cell tray in the stacking direction, wherein the through-hole for detecting the battery cell has a stepped portion defined inward from the battery cell tray in the stacking direction.

The lead accommodation part may be constituted by an electrode tab support part, which is provided at a predetermined height (d2) from a bottom surface of the cell seating part, and a groove connected to the electrode tab support part.

The battery cell tray may further include three or more cylindrical support parts between the cell seating parts disposed in a central portion of the main body.

### BRIEF DESCRIPTION OF THE DRAWINGS

Exemplary embodiments can be understood in more detail from the following description taken in conjunction with the accompanying drawings, in which:

FIG. 1A is a schematic perspective view of a battery cell tray for transporting a battery cell according to an embodiment of the present invention, FIG. 1B is a close-up perspective of a portion of a battery tray, FIG. 1C and FIG. 1D show close-up perspectives of a lead accommodation part of a battery cell tray;

FIG. 2A is a schematic perspective view of a bottom surface of the battery cell tray for transporting the battery cell shown in FIG. 1A, FIG. 2B is a close-up perspective of a support part of a battery cell tray, and FIG. 2C is a close-up perspective of a screw hole in a battery cell tray;

FIG. 3 is a cross-sectional view taken along line A-A′ of FIG. 1A;

FIG. 4 is a cross-sectional view taken along line B-B′ of FIG. 1A; and

FIG. 5 is an enlarged partial view of the battery cell tray for transporting the battery cell shown in FIG. 1A.

### DETAILED DESCRIPTION OF EMBODIMENTS

Hereinafter, battery cell trays for transporting battery cells (hereinafter, referred to as “battery cell trays”) according to the present invention will be described in detail with reference to accompanying drawings.

In the description with reference to the accompanying drawings, the same or corresponding components will be assigned the same reference numerals, and redundant descriptions thereof will be omitted.

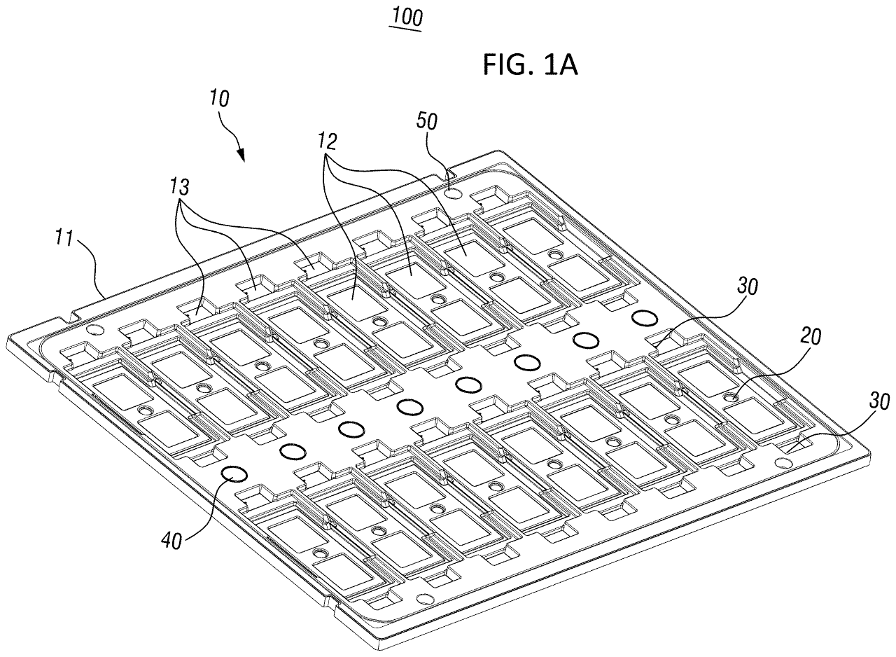

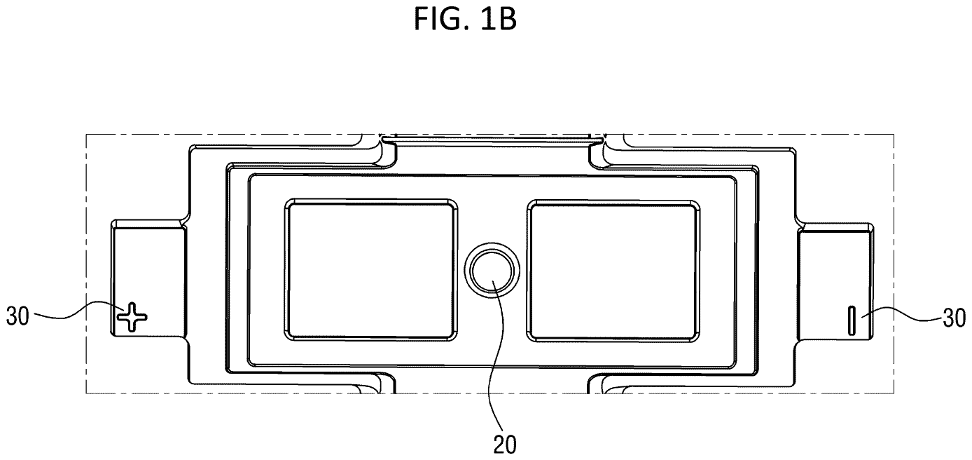

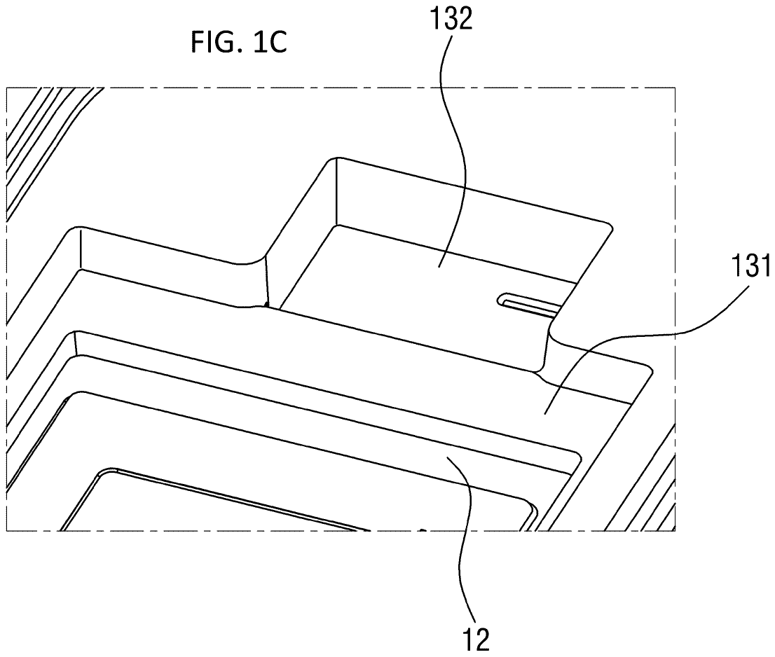

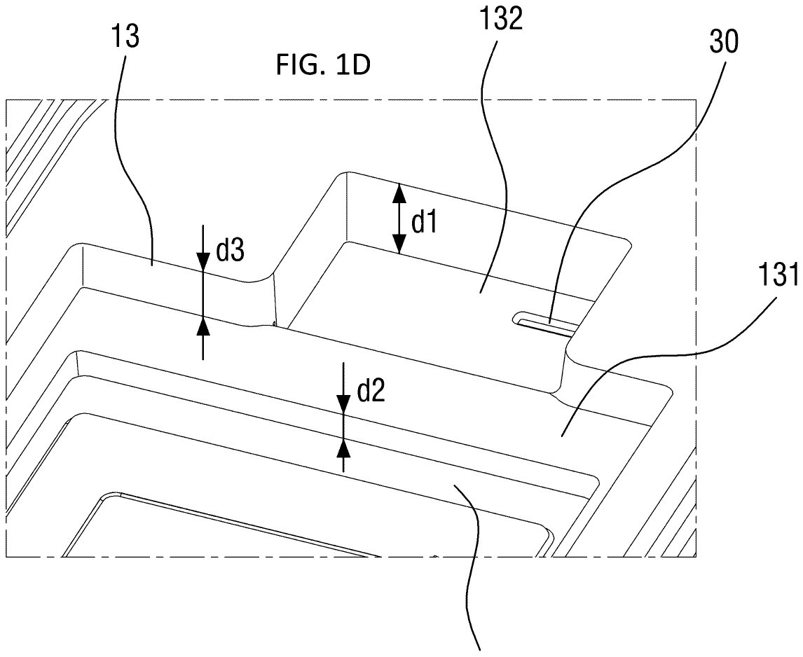

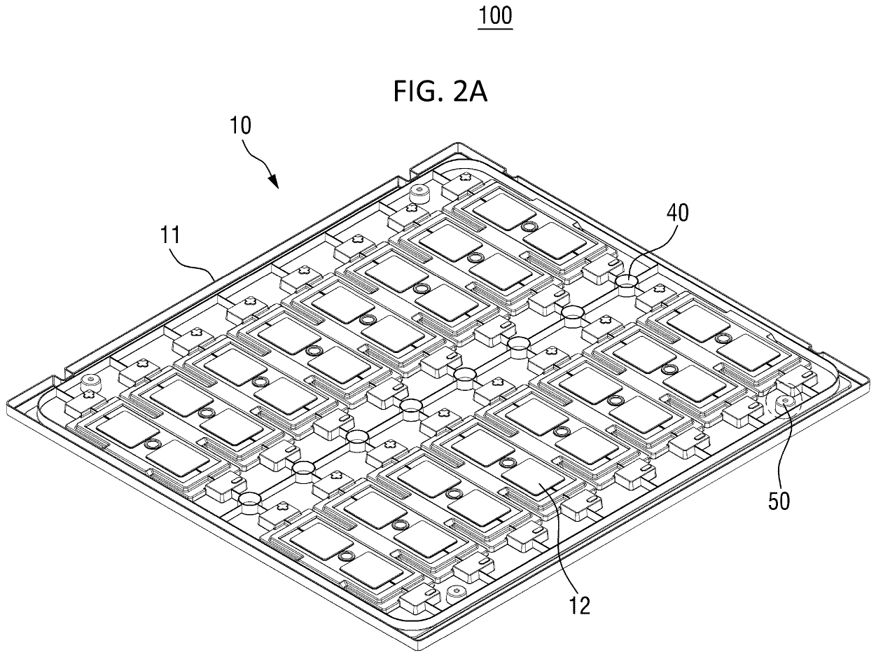

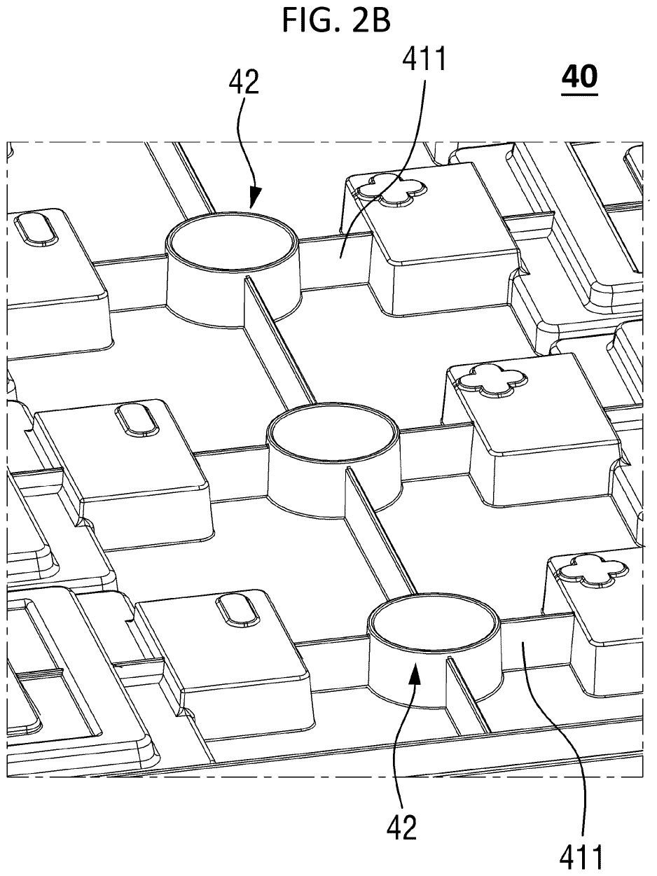

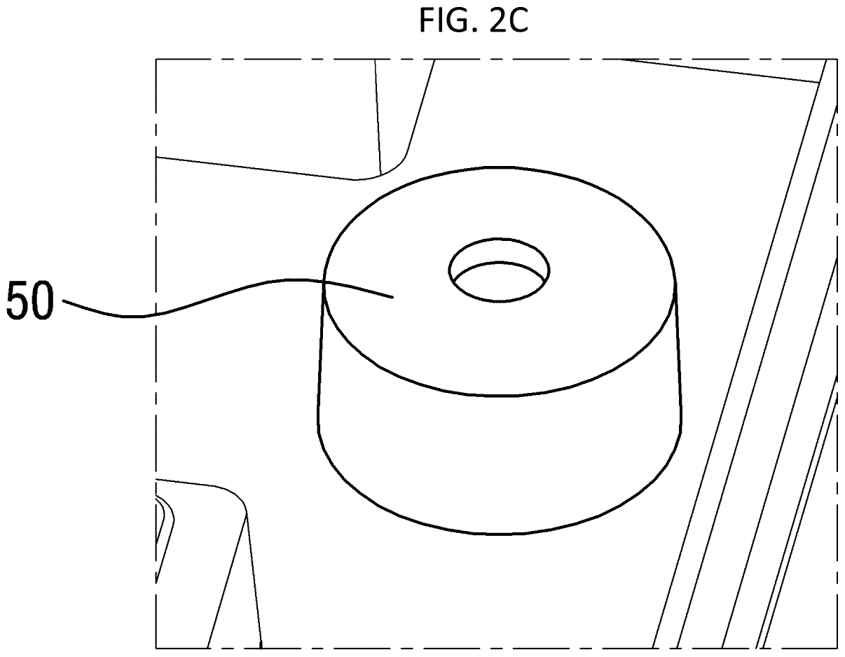

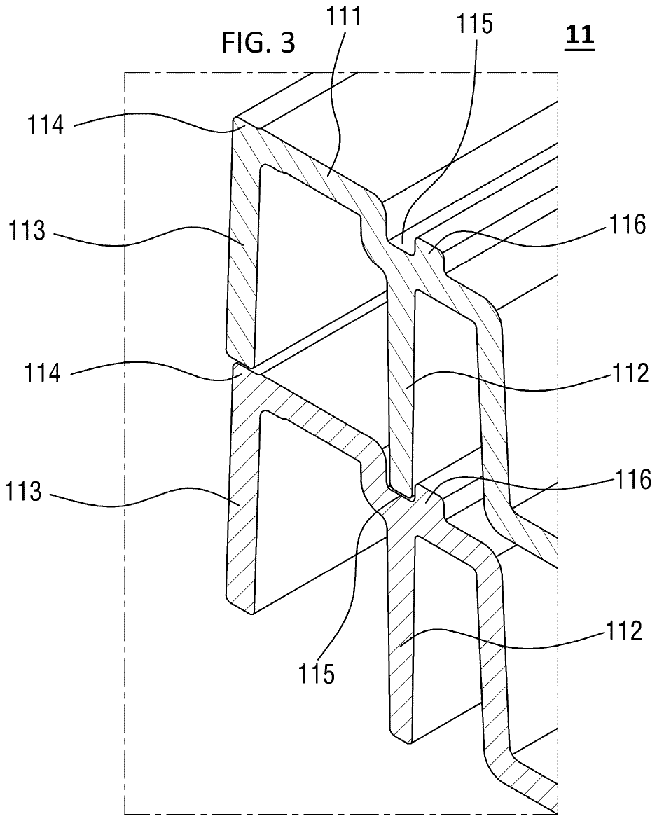

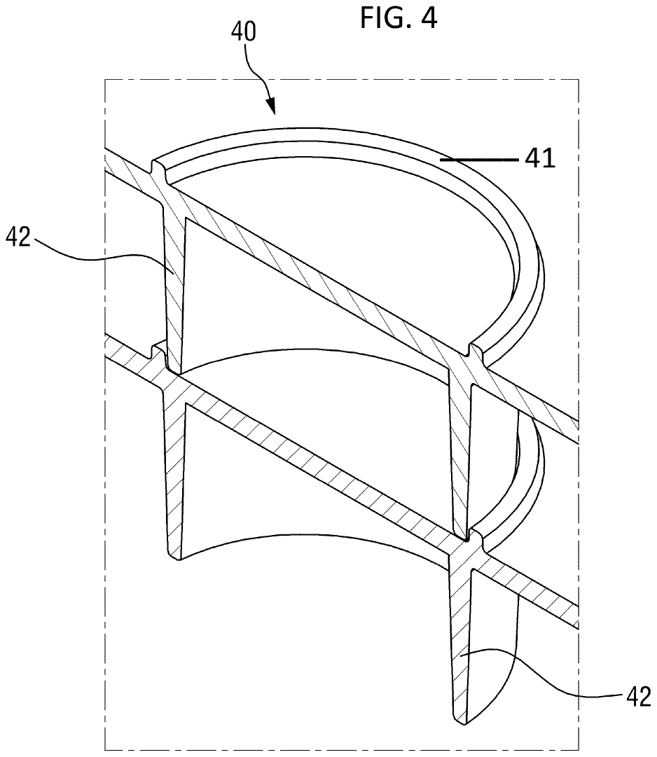

FIG. 1A is a schematic perspective view of the battery cell tray according to an embodiment of the present invention, and FIG. 3 is a cross-sectional view taken along line A-A′ of FIG. 1A. Also, FIG. 2A is a schematic perspective view of a bottom surface of the battery cell tray shown in FIG. 1A, and FIG. 4 is a cross-sectional view taken along lone B-B′ of FIG. 1A.

FIG. 1A is a schematic perspective view of the battery cell tray according to an embodiment of the present invention. Each of the battery cell trays according to the present invention is a device that may accommodate battery cells of a secondary battery to transport or store the battery cell. Each of the battery cells accommodated in the battery cell tray may be generally provided in a rectangular, plate-like shape.

Referring to FIG. 1A, the battery cell tray 100 according to an embodiment of the present invention includes a main body 10, and an edge part 11 defining an outer portion of the main body 10, wherein the main body 10 includes: one or more cell seating part 12 having a groove shape, to which battery cells are accommodated; and a lead accommodation part 13 in which a lead of the battery cell is accommodated, the lead accommodation part extending from both side portions of the cell seating part in a long-side direction.

The main body 10 defines an outer appearance of the battery cell tray 100, and a plurality of cell seating parts 12 are provided on the main body 10 to accommodate the battery cells therein. Each of the cell seating parts 12 on the main body may be a groove that is roughly rectangular in shape to accommodate the battery cell. The cell seating part 12 is constituted by a bottom surface on which the battery cell is seated and side walls that support the side surfaces of the battery cell.

Referring to FIG. 3, the edge part 11 is provided with a double-walled structure, which includes a top surface 111, an inner wall 112 and an outer wall 113 extending downward from the top surface to face each other, and a pair of bent corner parts 114 disposed between the top surface and the inner and outer walls. Each of the bent corner parts 114 is bent inward to allow the inner wall 112 or outer wall 113 of an upper stage battery cell tray to be disposed. Here, an inner bent corner part 114 is provided with a recess part 115 having a width greater than that of the inner wall 112. An inner end of the recess part 115 is provided with a rib 116 having a predetermined height to prevent foreign substances from being introduced into the cell seating part.

This double-walled structure is designed to prevent lateral movement when stacking the battery cell trays in multiple stages and serves to prevent in advance the detachment of the main body of the battery cell tray. Meanwhile, the rib 116 functions to prevent foreign substances from being introduced when vertically stacking the battery cell trays thereby protecting the battery cells against outer appearance damage such as scratches, dents, or scrapes.

Referring to FIG. 4, the battery cell tray 100 of the present invention includes a cylindrical support part 40, which prevents the battery cell tray from drooping when the battery cell trays are stacked in multiple stages on the center of the main body 10. Here, the cylindrical support part 40 is seated inside a cylindrical support part of the upper-stage battery cell tray in an inserted state. This cylindrical support part 40 is a portion to support a bottom surface of the battery cell.

The cylindrical support part 40 is provided with an edge protrusion 41, which protrudes at a predetermined height upward from the battery cell tray. A leg part 42 is provided on the bottom surface of the battery cell tray so that the leg part 42 of the upper-stage battery cell tray is seated inside an edge protrusion 41 of a lower-stage battery cell tray. Although the edge protrusion 41 has an annular shape, and the leg part 42 has a cylindrical shape in FIG. 4, these shapes are not limited thereto. The cylindrical support part 40 is disposed between neighboring cell seating parts 12 to prevent a central portion of the battery cell tray from drooping and to prevent foreign substances from being introduced into the cell seating part 12. Since the existing battery cell tray does not have a structure to prevent foreign substances, which generated during the vertical-coupling of the battery cell trays, from being introduced into the cell seating part, surface damage occurred on the battery cell tray.

The battery cell tray 100 according to the present invention is provided such that the upper-stage battery cell tray and the lower-stage battery cell tray are not in contact with each other, except for the edge part 11 and the cylindrical support part 40. That is, the steppe portion of the battery cell tray in the stacking direction may act as a stopper to prevent a bottom surface of the upper-stage battery cell tray from being in contact with a battery cell accommodated in the cell seating part 12 of the lower-stage battery cell tray. In the existing battery cell trays, a lower portion of a cell seating surface often showed significant wear marks due to friction, which caused the generation of foreign substances, and the foreign substances are introduced into the battery cells. However, in the battery cell tray according to the present invention, the friction portion between the upper-stage battery cell tray and lower-stage battery cell tray, which are stacked, may be minimized to reduce scratches and wear on the battery cell tray.

As shown in FIGS. 1A and 1B, battery cell tray 100 according to the present invention may include a polarity marking part 30, which is defined in an embossed or engraved shape on a surface of a lead accommodation part 13. In the existing battery cell trays, the polarity marking part that indicates the positive or negative terminal was embossed on the bottom surface of the cell seating part. Thus, it is difficult to check the polarity once the battery cell was seated, and the embossed portion may cause damage to the battery cell when foreign substances are detached when stacking the battery cells in multiple stages. In contrast, in the battery cell tray according to the present invention, the polarity marking part 30 may be engraved in the surface of the lead accommodation part 13 to minimize the friction portion. Also, the polarity marking part 30 may be defined in one side of the lead accommodation part 13 allowing the polarity to be checked even when the battery cell is seated. When the battery cell is seated with reversed polarity, it may cause damage to the battery cell, thus, the structure of the present invention may help prevent improper placement in advance.

Referring to FIG. 1 again to FIGS. 1A and 1B, the battery cell tray 100 according to the present invention includes a through-hole 20 for detecting the cell (hereinafter, referred to as a “cell detecting through-hole 20”), which visually confirm whether the battery cell is accommodated in the lower-stage battery cell tray in the stacking direction. The cell detecting through-hole 20 is defined in a central portion of the cell seating part 12. The cell detecting through-hole 20 has a stepped portion defined inward from the battery cell tray in the stacking direction. This stepped portion is a ring-shaped portion that extends along a circumference of the bottom surface and protrudes inward. In the existing cell trays, the cell detecting through-hole 20 is defined to be in directly contact with the battery cell. However, in the battery cell tray 100 according to the present invention, since the cell detecting through-hole 20 is designed so that the cell detecting through-hole 20 is not directly in contact with the battery cell, the portions where friction occurs with the product have been minimized.

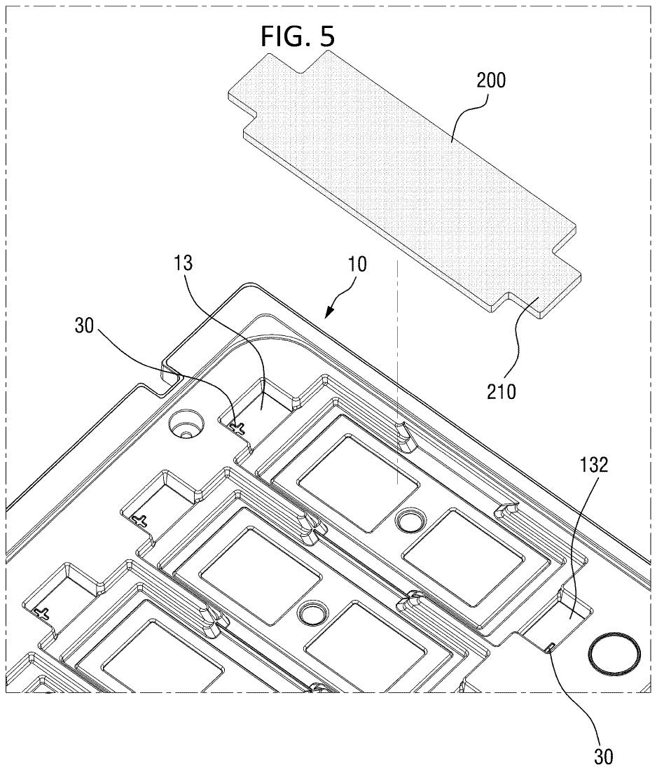

As shown in FIG. 5, battery cell 200 generally includes a battery case that defines an outer appearance, an electrode assembly accommodated in the battery case, an electrode lead 210 electrically connected to the electrode assembly to protrude outside the battery case, and an electrode tab that protrudes from the electrode assembly to allow the connection between the electrode lead and the electrode assembly. Generally, since the existing battery cell trays lack a seating part for the tabs, there is a limitation in that a tab portion is susceptible to damage. Referring to FIGS. 1A, 1C, and 1D, battery cell tray 100 according to the present invention includes an electrode tab support part 131, on which the electrode tab of the battery cell is seated.

The lead accommodation part 13 is constituted by the electrode tab support part 131, which is provided at a predetermined height d2 from a bottom surface of a portion in which the electrode tab of the cell seating part 12 starts, and a groove 132 connected to the electrode tab support part 131. A height dl from a bottom surface of the groove 132 is higher than that d2 from the bottom surface of the cell seating part 12 to the electrode tab support part 131 (d1>d2). Therefore, the electrode tab may be seated only on the electrode tab support part 131 without being in contact with the bottom surface of the groove 132 to prevent the electrode tab from bending or moving sideways, thereby protecting the electrode tab. In the present invention, the cell seating part 12 may be provided in a multi-stage structure with two or more stages.

Referring to FIGS. 2A and 2B, in the present invention, the leg part 42 of the cylindrical support part 40 is disposed between the cell seating parts 12 on the bottom surface of the battery cell tray. Also, a structure in which a cross-shaped linear rib 411 around the leg part 42 may be provided to prevent the battery cell tray from drooping. These linear ribs 411 extend to the lead accommodation parts arranged in parallel and to the adjacent leg parts 42. In the existing battery cell trays, the cross-shaped linear rib structure was provided, but the rib structure is insufficient to support battery cell trays stacked in multiple stages. However, in the battery cell tray according to the present invention, the leg part 42 of the cylindrical support part 40 may be disposed at the center of the cross-shaped linear ribs 411 to reinforce rigidity, thereby enhancing the drooping prevention function, even when multiple battery cell trays are stacked. Generally, when stacking the battery cell trays in multiple stages, two pocket-type fixing structures were disposed in the center to support a middle portion of the upper and lower neighboring battery cell trays. However, drooping occurred due to the weight of the product. In the present invention, to improve this limitation, the battery cell tray may be designed with a double-walled structure along the edge portions of four sides thereof, as well as, be provided with three or more, preferably eight or more cylindrical support parts 40 between the cell seating parts, which are arranged in parallel in the middle of the main body 10. These cylindrical support parts 40 may support the battery cell tray during the stacking.

In the battery cell tray according to the present invention, as shown in FIGS. 2A and 2C, screw holes 50 may further be defined in four edge portions of the main body 10 to couple the stacked battery cell trays to each other using screws.

The battery cell tray 100 according to the present invention may be manufactured by processing a plate-shaped member made of synthetic resin using methods such as injection molding or vacuum forming. According to one embodiment, the battery cell tray according to the present invention may consist of one or more resins selected from the group consisting of acrylonitrile-butadiene-styrene (ABS), polyester, styrene-butadiene copolymer, polystyrene, polyimide, polyamide, polysulfonate, polycarbonate, polyacrylate, and polyvinyl chloride.

The battery cell tray according to the present invention may be provided with the structure of which the edge portion is double-walled. This double-walled structure may entirely hold the four side surfaces of the plate-shaped battery cells, allowing for more stable coupling when stacking the battery cells in multiple stages.

According to the present invention, when stacking the battery cell trays in multiple stages, the cylindrical support part of the lower-stage battery cell tray may be seated inside the cylindrical support part of the upper-stage battery cell tray in the stacking direction, preventing the battery cell tray from drooping. Additionally, the edge protrusion may prevent the introduction of foreign substances, thereby protecting the battery cell tray and minimizing problems such as product defects.

In addition, according to the present invention, there is no splitting or damage of the battery cell tray, and there is no outer appearance damage such as scratches, dents, creases, or scrapes on the surface of the battery cell tray. Therefore, it may reliably prevent the battery cells from being detached during the stacking.

Although the embodiments of the present invention have been described, it is understood that the present invention should not be limited to these embodiments, but various changes and modifications can be made by one ordinary skilled in the art within the spirit and scope of the inventive concept as hereinafter claimed.

Therefore, the technical scope of the present invention should not be limited to the content described in the detailed description of the specification but should be defined by the claims.

1. A battery cell tray comprising:
a main body; and
an edge part defining an outer portion of the main body;
wherein the main body comprises:
at least one cell seating part having a groove shape; and
a lead accommodation part extending from both side portions of the cell seating part in a long-side direction, wherein
the edge part has a double-walled structure constituted by a top surface, inner and outer walls extending downward from the top surface to face each other, and a pair of bending corner parts provided between the top surface and the inner and outer walls,
an inner wall is seated in a recess part in which the inner wall is accommodated, and
a rib is defined at a predetermined height on an inner end of the recess part to prevent foreign substances from being introduced to the cell seating part.

2. The battery cell tray of claim 1, further comprising:
a plurality of cylindrical support parts disposed between the cell seating parts in a center of the main body,
wherein each of the cylindrical support part comprises:
an edge protrusion protruding at a predetermined height upward from a surface of the battery cell tray, and
a leg part disposed on a bottom surface of the battery cell tray, and wherein further the battery cell tray is an upper-stage battery cell tray, and
the leg part of the battery cell tray is seated inside an edge protrusion of a lower-stage battery cell tray.

3. The battery cell tray of claim 2, further comprising a drooping prevention structure in which a cross-shaped linear rib is provided around the leg part.

4. The battery cell tray of claim 2, wherein surfaces of the upper-stage battery cell tray and the lower-stage battery cell tray are not in contact with each other except for the edge part and the cylindrical support parts.

5. The battery cell tray of claim 2, further comprising:
a through-hole defined in a central portion of the cell seating part to view the lower-stage battery cell tray in a stacking direction of a plurality of the battery cell tray in multiple stages,
wherein the through-hole has a stepped portion defined inward from the battery cell tray in the stacking direction.

6. The battery cell tray of claim 1, wherein the lead accommodation part is constituted by an electrode tab support part, which is provided at a predetermined height (d2) from a bottom surface of the cell seating part, and a groove connected to the electrode tab support part.

7. The battery cell tray of claim 2, further comprising three or more cylindrical support parts.

8. The battery cell tray of claim 1, further comprising a polarity marking part defined in an embossed or engraved shape on a surface of the lead accommodation part.
